(19) United States
(12) Patent Application Publication
(10) Pub. No.: US 2003/0140964 A1
(43) Pub. Date: Jul. 31, 2003

(54) Air escape valve

(76) Inventor: Thomas M. O'Donnell, Minooka, IL (US)

Correspondence Address: Ernest S. Kettelson, KETTELSON LAW OFFICES, LTD., Wynderidge Place, Post Office Box 2517, Joliet, IL, 60434, US

(21) Appl. No.: 10/058,246

(22) Filed: Jan. 29, 2002

(51) Int. Cl. F16K 24/04

(52) U.S. Cl. 137/202

(57) ABSTRACT

An air escape valve for a water line having a float switch mounted in a chamber connected to the water line. The float switch is connected to a solenoid valve that controls an air escape passageway from the chamber. The float switch is moved to the contact closed position and the solenoid valve to the valve closed position when water flows normally in the water line with sufficient water flowing into the chamber to raise and hold the float switch to the contact closed position. When enough air has entered the line to impede water flow, the water level in the chamber drops allowing the float switch to drop out of its contact closed position. This opens the electrical circuit to the solenoid so the solenoid valve no longer remains in its valve closed position, but moves to its normally biased valve open position. The air escape passageway is then open to allow the built-up air to escape, whereupon the water flow can return to normal. Enough water can then flow into the chamber to raise the float switch back up to its contact closed position, thus completing the electrical circuit to the solenoid. When the electrical circuit is completed the solenoid is again energized and the solenoid valve moved to its valve closed position to again close the air escape passageway until the next build-up of air occurs at which time the air escape process is repeated automatically.

### FIELD OF THE INVENTION

This invention relates to the field of devices to purge air from water lines.

### BACKGROUND OF THE INVENTION

Water lines of all kinds have a continuing problem of air eventually building up therein which impedes the proper flow of water. Many different ways of attempting to solve this problem have been known in the prior art. The invention herein provides an air escape valve that is an improvement over the prior art. Prior art devices known to the inventor include those disclosed in the following United States Patents which are readily available to the public and other interested parties in a number of public libraries, over the internet, and in the United States Patent and Trademark Office:

U.S. Pat. No. 5,816,282

U.S. Pat. No. 3,665,156

U.S. Pat. No. 3,618,690

U.S. Pat. No. 3,260,815

U.S. Pat. No. 3,195,557

U.S. Pat. No. 3,084,706

U.S. Pat. No. 2,957,060

U.S. Pat. No. 2,613,294

U.S. Pat. No. 1,481,470

U.S. Pat. No. 1,406,196

### SUMMARY OF THE INVENTION

The present invention provides an improved air escape valve in a water line system for water purification or whatever, wherein it is necessary from time to time to purge air from the line.

The valve comprises a cylindrical chamber having a fitting connecting to the water line. When water is flowing in the line, some of it flows through the fitting into the cylindrical chamber where it raises a float switch having a contact element or elements on its upper surface. An elongated sleeve extends down inside the cylindrical chamber from an upper cap. The elongated sleeve opens at its upper end to the upwardly facing end wall of the upper cap. A terminal support fitting is threaded into the opening at the lower end of the elongated sleeve. A pair of spaced apart electrical contacts project downwardly from the terminal support fitting for contact with the contact element or elements on the upper surface of the float switch when water in the chamber raises the float to the contact closed position. The spaced apart contacts of the terminal support fitting then make electrical contact with the corresponding contact element or elements on the float switch.

A pair of wires or conductors extend upwardly from respective ones of the pair of contacts of the terminal support fitting through the elongated sleeve and out through its open upper end. One of those wires is connected to one of the terminals of a solenoid operated valve mounted on top of the cylindrical chamber. The other is connected to one of the wires of an electrical cord that is connectable to a power source. The second wire of the electrical cord is connected to the other terminal of the solenoid.

When water flows in the line at its proper regular rate, a sufficient amount of water enters the cylindrical chamber to raise the float switch to its closed contact position to complete an electrical circuit with the pair of spaced apart contacts on the terminal support fitting, the conductors leading therefrom, one to a terminal of the solenoid, the other to a power source conductor wose other conductor is connected to the other terminal of the solenoid to thereby energize the solenoid. That in turn operates the solenoid valve to move it to its valve closed position.

When water flow in the line is interrupted or impeded, so insufficient water flows into the cylindrical chamber to keep the float switch in its raised contact closed position, the float switch then drops and separates from its closed contact relationship with the pair of contacts on the terminal support fitting cutting off power to the solenoid. The solenoid valve is then moved to its normally biased valve open position to open the passageway of a tubular air outlet or air escape fitting controlled by the solenoid valve. The tubular air outlet fitting is located on upwardly facing end wall of the upper cap of the cylindrical chamber, and allows air to escape from the water line and chamber until the line has been purged of enough air to again flow normally. The cylindrical chamber then fills with a sufficient amount of water to raise the float switch to its contact closed position in contact with the pair of spaced apart contacts on the terminal support fitting, thereby energizing the solenoid which in turn operates the solenoid valve and moves it to the valve closed position.

The improved air escape valve in accordance with this invention has made it possible to automatically purge air from the water line on a continuous basis without constant attention.

### BRIEF DESCRIPTION OF THE DRAWING

FIG. 1 is an elevation view of an air escape valve in accordance with this invention shown connected to a water line.

FIG. 2 is a section view of the air escape valve seen in FIG. 1 showing the interior of the valve chamber and the float valve assembly therein, the float valve assembly shown in the contact closed position.

FIG. 3 is a section view of the air escape valve seen in FIG. 2 but with the float valve assembly shown in the contact open position.

FIG. 4 is an elevation view of the float valve assembly shown disconnected from the elongated sleeve seen in FIGS. 1 and 2.

FIG. 5 is a section view taken on line 5-5 of FIG. 4.

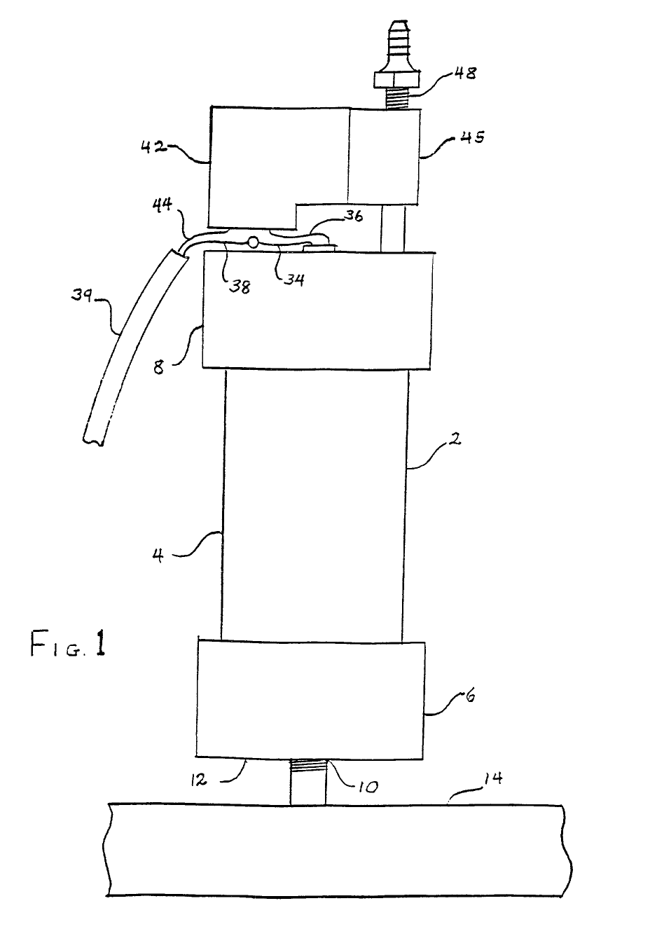

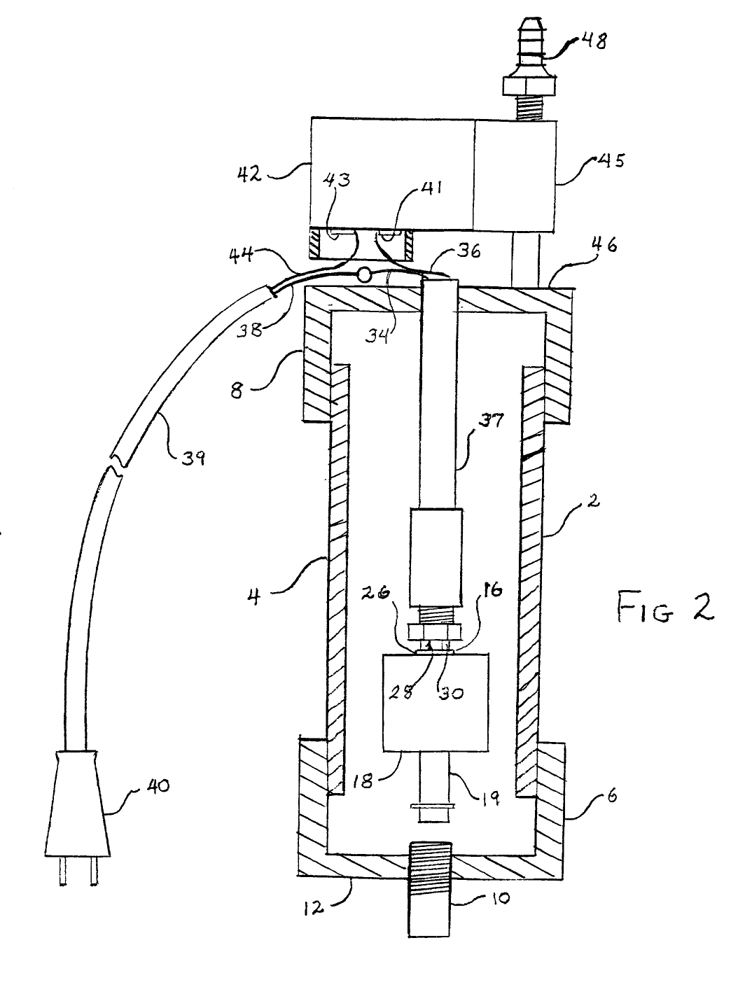

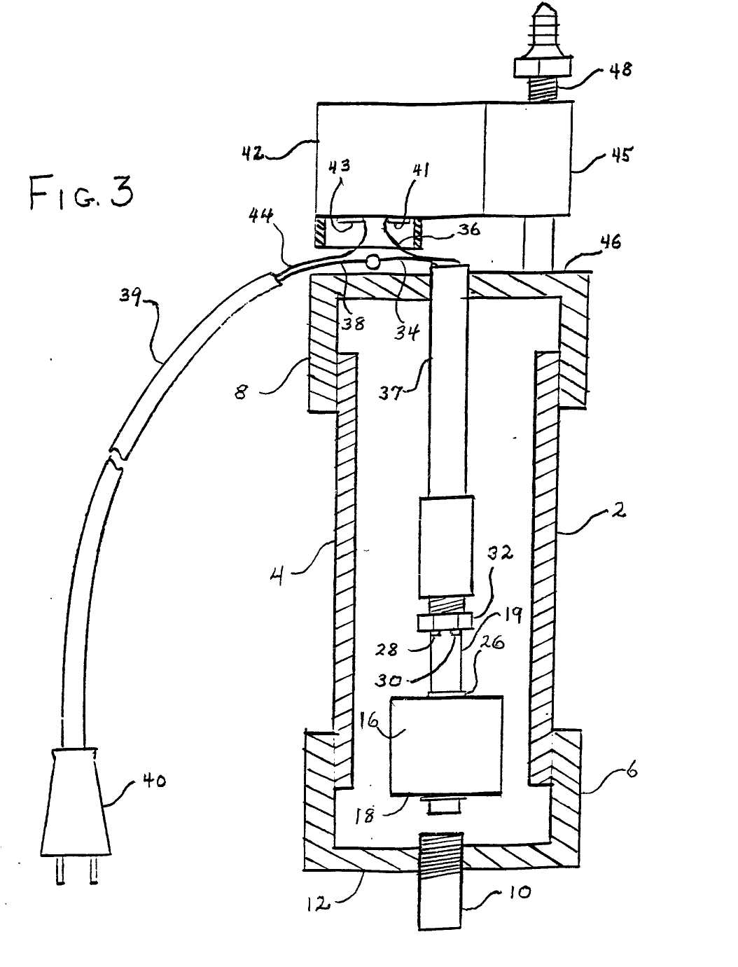

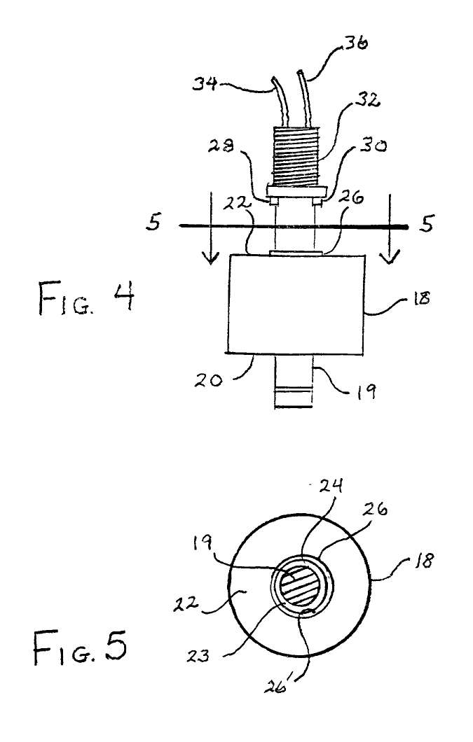

### DESCRIPTION OF PREFERRED EMBODIMENT

An air escape valve 2 in accordance with this invention comprises a cylindrical chamber 4 having a lower cap 6 threaded on the lower end of the cylindrical chamber 4, and an upper cap 8 threaded on the upper end thereof. One end of a tubular fitting 10 is received in the center of the end wall 12 of the lower cap 6, and its opposite end is connected to a water line 14.

When water is flowing in the water line 14, some of the water flows through the fitting 10 into the cylindrical chamber 4 where it raises a float switch assembly 16. The float switch assembly 16 includes a cylindrical float body 18 to slidingly receive the elongated guide shaft 19, a bottom end wall 20 and a top end wall 22. A cylindrical bore 24 extends through the cylindrical float body 18. An electrical contact member 26 comprising a copper ring is provided within and around the upper opening 23 to the cylindrical bore 24. A pair of electrical contacts 28 and 30 extend downwardly from the lower end of a coupling assembly 32 for contact with the copper ring contact member 26 when the float switch assembly 16 is raised by water flowing into the cylindrical chamber 4. The contacts 28 and 30 then complete an electrical circuit through the electrical contact member 26. The float switch assembly 16 and contacts 28 and 30 are then in the contact closed position.

The electrical contact member 26 preferably comprises a cylindrical copper ring member having a circumferential contact surface 26′ of a dimension corresponding to the distance the contacts 28 and 30 are spaced apart, including an outer diameter slightly greater than such distance and an inner diameter slightly less than such distance, whereby electrical contact is made with both contacts 28 and 30 when the float switch assembly 16 is moved to the contact closed position to complete an electrical circuit between contacts 28 and 30.

The contacts 28 and 30 are connected respectively to electrical conductors or wires 34 and 36. Conductors 34 and 36 extend upwardly through the passageway of the coupling assembly 32, which is threaded into the lower end of an elongated sleeve 37, and then continuing upwardly through the passageway of elongated sleeve 37 that opens to the end wall of the upper cap 8 from which it extends downwardly into the cylindrical chamber 4.

Conductor 34 extends through the opening in the end wall of the upper cap 8 where it is connected to conductor 38 of an electrical cord 39 having a plug 40 for connection to a power source. Conductor 36 extends through the same opening in the upper cap 8 where it is connected to terminal 41 of a solenoid 42. Terminal 43 of the solenoid 42 is connected to conductor 44 of the electrical cord 39 and its plug 40 for connection to a power source.

The solenoid 42 operates a solenoid valve 45 positioned above the upwardly facing end wall 46 of the upper cap 8. The solenoid valve 45 is connected in an air exhaust line or fitting 48, the lower end of which is threaded into an aperture through the end wall 46 of the upper cap 8 to provide an outlet passageway for exhausting air from the cylindrical chamber 4 when the solenoid valve 45 is in the valve open position.

As water is flowing in the water line 14 it also enters through the tubular fitting 10 into the cylindrical chamber 4 to raise the float switch assembly 16. The contact member 26 is moved into the contact closed position in contact with the pair of contacts 28 and 30. This completes a circuit between the contacts 28 and 30 of the coupling assembly 32, through the conductors 34 and 36, through conductors 38 and 44 of the electrical cord connectable to a power source, and the terminals 41 and 43 of the solenoid 42.

Thus, when water is flowing in the water line 14 and the float switch assembly 16 is moved upward into the contact closed position, the solenoid 42 is energized and the solenoid valve 45 is moved to the valve closed position to close the air exhaust line 48.

Air is purged from the water line 14 when water is not flowing. At such time, water does not flow into the cylindrical chamber 4 thereby causing the float switch assembly 16 to drop. That in turn separates the contact member 26 from contacts 28 and 30 of the coupling assembly 32. This opens the circuit leading to the terminals 41 and 43 of the solenoid 42. When a circuit is no longer completed between the solenoid terminals 41 and 43, the solenoid 42 is no longer energized and moves to the position which opens the solenoid valve 45. This opens the air exhaust line 48 permitting air to escape from the water line 14 through the cylindrical chamber 4 and exhaust line 48 to the ambient atmosphere.

I claim:

1. An air escape valve comprising a chamber, said chamber operatively associated with an inlet passageway and an outlet passageway, connection means for connecting said inlet passageway of said chamber to a water line for admission of water into said chamber when water is flowing in said water line, said inlet passageway being continuously open to said chamber and to said water line when so connected, a valve mechanism operatively associated with said outlet passageway and movable between a valve open position to open said outlet passageway and a valve closed position to close said outlet passageway, a switch mechanism operatively associated with said valve mechanism to operate said valve mechanism, said switch mechanism being operable between a first position and a second position, said switch mechanism being operable to a one of said positions when water is flowing in said water line and into said chamber to at such time operate said valve mechanism to move to its said valve closed position and being operable to the other one of said positions when water is not flowing into said chamber to at such time operate said valve mechanism to move to its said valve open position to enable air to escape from said chamber and from said water line.

2. An air escape valve as set forth in claim 1, wherein said connection means comprises a tubular fitting having a first end and an opposite second end, said first end being connected to said inlet passageway of said chamber, said second end being connected to said water line.

3. An air escape valve as set forth in claim 2, wherein said tubular fitting is continuously open to provide a continuously open through passageway between said water line and said chamber.

4. An air escape valve as set forth in claim 1, wherein said valve mechanism includes a solenoid having a first terminal and a second terminal for connection in an electrical circuit.

5. An air escape valve as set forth in claim 4, wherein said switch mechanism includes a first conductor and a second conductor, a contact mechanism movable between a contact closed position to complete an electrical circuit between said first and second conductors and a contact open position to interrupt the electrical circuit between said first and second conductors.

6. An air escape valve as set forth in claim 5, wherein one of said conductors of said switch mechanism is connected to said first terminal of said solenoid.

7. An air escape valve as set forth in claim 6, wherein the other of said conductors of said switch mechanism is connected to a power source.

8. An air escape valve as set forth in claim 7, including an electrical cord connectable to a power source having a first electrical cord conductor and a second electrical cord conductor, wherein said other of said conductors of said switch mechanism is connected to said first electrical cord conductor, and said second electrical cord conductor is connected to said second terminal of said solenoid.

9. An air escape valve as set forth in claim 5, wherein said contact mechanism of said switch mechanism includes a terminal support member and a pair of spaced apart contacts thereon, a floatable contact member movable between a contact closed and contact open position, said floatable contact member having contact means for contact with said pair of spaced apart contacts on said terminal support member to complete an electrical circuit between said spaced apart contacts when said floatable contact member is moved into said closed contact relationship with said terminal support member, said floatable contact member being movable to said contact closed position when water is flowing in said water line and into said chamber.

10. An air escape valve as set forth in claim 9, wherein said floatable contact member separates from said terminal support member and moves to said contact open position when water is not flowing into said chamber and not flowing in said water line.

11. An air escape valve as set forth in claim 9, wherein said switch mechanism includes an elongated guide member extending from said terminal support member, said floatable contact member comprises a float body having an upwardly facing wall portion facing toward said terminal support member, an elongated passageway through said float body having an upper aperture opening to said upwardly facing wall portion, said elongated guide member of said terminal support member being received through said elongated passageway through said float body for reciprocating movement of said floatable contact member along said elongated guide member, said contact means of said floatable contact member comprising an electrical conductor positioned for contact with both of said spaced apart contacts of said terminal support member when said floatable contact member is moved to its said contact closed position.

12. An air escape valve as set forth in claim 11, wherein said upper aperture of said passageway through said float body is cylindrical, said electrical conductor positioned for contact with both of said spaced apart contacts of said terminal support member comprises an electrically conductive ring member mounted in said cylindrical upper aperture having an upwardly facing circumferential contact surface of sufficient diameter to contact both of said spaced apart contacts when said floatable contact member is in its said contact closed position.
